(19) United States
(12) Patent Application Publication
(10) Pub. No.: US 2008/0264719 A1
(43) Pub. Date: Oct. 30, 2008

(54) SILENCER

(75) Inventors: Naohito Seko, Kariya-city (JP); Toshiaki Nakayama, Nishikamo-gun (JP); Yoshitaka Nishio, Nagoya-city (JP); Seiji Tachibana, Toyoake-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/101,731

(22) Filed: Apr. 11, 2008

(30) Foreign Application Priority Data
Apr. 27, 2007 (JP) 2007-119651
Dec. 20, 2007 (JP) 2007-328759

(51) Int. Cl. F02M 35/12; F01N 1/00

(52) U.S. Cl. 181/229; 181/247

(57) ABSTRACT

A silencer for attenuating a sound includes an inner duct in which gas flows, and an outer duct surrounding the inner duct with a gas layer formed between the outer duct and the inner duct. The sound is generated in one of an upstream side of the inner duct in a gas flow direction, a downstream side of the inner duct in the flow direction, and an inside of the inner duct. The inner duct includes a thin film over its entire surface. The film has a first reinforcement section formed in a direction parallel to the flow direction, and a plurality of vibrating surfaces. The film is bent at the first reinforcement section. Each combination of adjacent two of the plurality of vibrating surfaces is connected by the first reinforcement section. The first reinforcement section of the inner duct is fixed to the outer duct.

### CROSS REFERENCE TO RELATED APPLICATION

This application is based on and incorporates herein by reference Japanese Patent Application No. 2007-119651 filed on Apr. 27, 2007 and Japanese Patent Application No. 2007-328759 filed on Dec. 20, 2007.

### BACKGROUND OF THE INVENTION

1. Field of the Invention

The present invention relates to a silencer, which attenuates a sound generated on an upstream side, on a downstream side, or inside of a duct in which gas flows, for example, a silencer that is suitably used for an air intake duct of an internal combustion engine.

2. Description of Related Art

A resonator for reducing suction noise in a suction passage is conventionally provided, for example, as measures against the noise of an engine of an automobile. The above resonator has a volume part provided in the middle of the suction passage, and reduces the sound having a specific frequency which flows through the suction passage. The resonator has a vibrating membrane between the suction passage and the volume part. By vibrating the vibrating membrane, a pressure wave in opposite phase of the suction noise is formed to resonate with the suction noise, thereby reducing the suction noise, as described, for example, in JP2004-293365A.

Also, a double pipe structure having a cover body covering the through hole for noise reduction, which is bored on an air intake duct, with a space held around a outer surface of the air intake duct, is known as the method of reducing the suction noise of the engine, as described, for example, in JP2001-73894A.

As the method of reducing the suction noise of the engine, as described, for example, in JP2004-346750A, a synthetic resin film, through which an acoustic wave permeates, is stacked on an inner or outer surface of a cylindrical duct having many openings, and then a cylindrical outer duct is disposed outside of the inner duct.

Furthermore, as described, for example, in JP63-266492A, a silencer having a double pipe structure equipped with an inner tube defining a passage made of a thin-walled viscoelastic membrane, and an outside tube surrounding the inner tube formed from a hollow rigid pipe is known as the method of reducing the suction noise of the engine or the like.

However, the resonator described in JP2004-293365A requires the large volume chamber for resonance in the middle of the suction passage, and thus a suction passage portion inevitably grows in size. In addition, the resonator reduces only the sound having a specific frequency. When it reduces sound having wideband frequencies, two or more resonators need to be provided, and thereby they take up a large space in an engine compartment.

In the air intake duct shown in JP2001-73894A having a double pipe structure, in which the through hole for noise reduction is bored, some effect of reducing the sound having wideband frequencies is expected in high frequency. However, in low frequency, it is necessary to enlarge a hole diameter and to form a deeper hole. Thus the volume of the air intake duct is necessarily made large. Accordingly, the double pipe structure inevitably grows in size. Moreover, a pressure loss in the inner duct is large due to the influence of the hole.

In the air intake duct having the double pipe structure shown in JP2004-346750A, in which the synthetic resin film that an acoustic wave permeates is stacked on the cylindrical duct having many openings, a cylindrical film is used for being stacked on many openings. The rigidity due to a shape of the film is great, and thereby it is difficult for an acoustic wave to permeate. As a result, a sufficient silencing effect is difficult to produce. In order to produce the sufficient silencing effect, a film thickness needs to be ultra-thin, so that the air intake duct has a problem of strength. In addition, by employing many openings formed in the duct, a silencing effect is easily produced in a broad frequency range. However, a sufficient silencing effect on a comparatively high sound pressure in a narrow band is difficult to produce.

In the silencer shown in JP63-266492A including the inner tube formed from a thin-walled viscoelastic membrane, and the outside tube made of the hollow rigid pipe, the inner tube is easy to greatly deform when positive/negative pulsating pressures of air are generated in the inner tube, and thereby a large pressure is applied to a thin-walled viscoelastic membrane. As a result, there is a problem that the silencer does not have sufficient strength.

### SUMMARY OF THE INVENTION

The present invention addresses the above disadvantages. Thus, it is an objective of the present invention to provide a silencer, which attenuates a sound having a comparatively high sound pressure in a narrow range as well as a sound in a comparatively broad frequency range generated in an inner duct, and which improves durability of the inner duct. In addition, it is another objective of the present invention to accomplish the above objective by employing a relatively simple structure in the silencer.

To achieve the objective of the present invention, there is provided a silencer for attenuating a sound. The silencer includes an inner duct and an outer duct. Gas flows in the inner duct, and the outer duct is configured to surround an outside of the inner duct with a layer of gas formed between the outer duct and the inner duct. The sound is generated in one of an upstream side of the inner duct in a flow direction of gas, a downstream side of the inner duct in the flow direction of gas, and an inside of the inner duct. The inner duct includes a thin film over an entire surface thereof. The thin film has a first reinforcement section that is formed in a direction parallel to the flow direction of gas, and a plurality of vibrating surfaces. The thin film is bent at the first reinforcement section. Each combination of adjacent two of the plurality of vibrating surfaces is connected by the first reinforcement section. The inner duct is fixed to the outer duct such that the first reinforcement section of the inner duct is fixed to the outer duct. Additionally, the above entire surface of the inner duct includes a generally entire surface of the inner duct, and the first reinforcement section may be formed in a direction generally parallel to the flow direction of gas.

To achieve the objective of the present invention, there is also provided a silencer for attenuating a sound. The silencer includes an inner duct and an outer duct. Gas flows in the inner duct, and the outer duct is configured to surround an outside of the inner duct with a layer of gas formed between the outer duct and the inner duct. The sound is generated in one of an upstream side of the inner duct in a flow direction of gas, a downstream side of the inner duct in the flow direction of gas, and an inside of the inner duct. The inner duct includes a thin film over an entire perimeter thereof. The thin film has a first reinforcement section that is formed in a direction parallel to the flow direction of gas, and a plurality of vibrating surfaces. The thin film is bent at the first reinforcement section. Each combination of adjacent two of the plurality of vibrating surfaces is connected by the first reinforcement section. The first reinforcement section of the inner duct is in contact with an inner circumferential surface of the outer duct when gas does not flow in the inner duct. In addition, the above entire perimeter of the inner duct includes a generally entire perimeter of the inner duct, and the first reinforcement section may be formed in a direction generally parallel to the flow direction of gas.

Furthermore, to achieve the objective of the present invention, there is provided a silencer for attenuating a sound. The silencer includes an inner duct and an outer duct. Gas flows in the inner duct, and the outer duct is configured to surround an outside of the inner duct with a layer of gas formed between the outer duct and the inner duct. The sound is generated in one of an upstream side of the inner duct in a flow direction of gas, a downstream side of the inner duct in the flow direction of gas, and an inside of the inner duct. The inner duct includes a thin film over an entire perimeter thereof. The thin film has a first reinforcement section that is formed in a direction parallel to the flow direction of gas, and a plurality of vibrating surfaces. The thin film is bent at the first reinforcement section. Each combination of adjacent two of the plurality of vibrating surfaces is connected by the first reinforcement section. The first reinforcement section of the inner duct is brought into contact with an inner circumferential surface of the outer duct when the inner duct is deformed in a direction of the outer duct duet to a change of pressure of gas. Additionally, the above entire perimeter of the inner duct includes a generally entire perimeter of the inner duct, and the first reinforcement section may be formed in a direction generally parallel to the flow direction of gas.

### BRIEF DESCRIPTION OF THE DRAWINGS

The invention, together with additional objectives, features and advantages thereof, will be best understood from the following description, the appended claims and the accompanying drawings in which:

FIG. 1A is a longitudinal sectional view illustrating a configuration of a silencer according to a first embodiment of the invention;

FIG. 1B is a cross-sectional view taken along a line IB-IB in FIG. 1A;

FIG. 2 is a schematic view illustrating a configuration of a chief portion of a silencer according to a second embodiment of the invention;

FIG. 3 is a schematic longitudinal sectional view illustrating a fixing position of the silencer according to the first or second embodiment;

FIG. 4A is a longitudinal sectional view illustrating a configuration of a silencer according to a third embodiment of the invention;

FIG. 4B is a cross-sectional view taken along a line IVB-IVB in FIG. 4A;

FIG. 5A is a longitudinal sectional view illustrating a configuration of a silencer according to a fourth embodiment of the invention;

FIG. 5B is a cross-sectional view taken along a line VB-VB in FIG. 5A;

FIG. 6A is a longitudinal sectional view illustrating a configuration of a silencer according to a fifth embodiment of the invention;

FIG. 6B is a cross-sectional view taken along a line VIB-VIB in FIG. 6A;

FIG. 7A is a longitudinal sectional view illustrating a configuration of a silencer according to a sixth embodiment of the invention;

FIG. 7B is a cross-sectional view taken along a line VIIB-VIIB in FIG. 7A;

FIG. 8A is a longitudinal sectional view illustrating a configuration of a silencer according to a seventh embodiment of the invention;

FIG. 8B is a cross-sectional view taken along a line VIIIB-VIIIB in FIG. 8A;

FIG. 9A is a cross-sectional view illustrating an inner duct of a silencer according to an eighth embodiment of the invention;

FIG. 9B is a cross-sectional view illustrating an inner duct of a silencer according to an ninth embodiment of the invention;

FIG. 10A is an enlarged cross-sectional view illustrating a part of an outer duct of the silencer according to the first embodiment;

FIG. 10B is an enlarged cross-sectional view illustrating a part of a modified example of the outer duct according to the first embodiment;

FIG. 10C is an enlarged cross-sectional view illustrating a part of a modified example of the outer duct according to the first embodiment;

FIG. 11A is a graph illustrating noise reduction characteristics of the silencer according to the invention; and

FIG. 11B is a graph illustrating noise reduction characteristics of the silencer according to the invention.

### DETAILED DESCRIPTION OF THE INVENTION

The invention is illustrated in detail with the following embodiments. In the embodiments, the same numeral is given to substantially the same component, and the description of the same component is omitted.

### First Embodiment

A silencer of a first embodiment of the invention is disposed on an upstream side of an internal combustion engine, and is used as an air intake duct through which intake air flows to the engine.

An outer duct 1 is formed from resin. A major diameter portion of the outer duct 1 is constituted of an upper duct and a lower duct that are coupled together at a flanged portion 10 to have a generally cylindrical shape. A diameter of the major diameter portion is reduced, and its both ends are connected to an inlet side passage part 5 and an outlet side passage part 6. The inlet side passage part 5 communicates with an air cleaner of the engine, and the outlet side passage part 6 communicates with an intake manifold of the engine.

An inner duct 2 is fixed in the outer duct 1. The whole circumference of the inner duct 2 is formed from a film (thin film) of resin, and a cross-sectional surface of the inner duct 2 along a line IB-IB has a hexagonal shape. PEN (polyethylenenaphthalate), for example, is used as a resin material of the inner duct 2, and the film is 125 micrometers in thickness. Other materials may also be used as the thin film of resin, and a thinner or thicker film may be used for the inner duct 2.

The inner duct 2 is formed from the film of resin to have a hexagonal cross-sectional surface so as to define a passage 4 therein, and a plurality of planar vibrating surfaces is formed on the inner duct 2. The vibrating surfaces are connected to each other at reinforcement sections 22, 24, which are formed in the film bent portions where the film is bent. The reinforcement section 22 is formed in a direction generally parallel to a flow direction of an intake air. The reinforcement section 24 is formed in a direction generally perpendicular to the flow direction of the intake air. In addition, the inner duct 2 may be formed from resin by blow molding, or may be formed by bending the film of resin. Furthermore, the inner duct 2 may be formed otherwise than the above methods. In the first embodiment, the film is bent sharply at the film bent portions. Alternatively, it may be bent smoothly at the film bent portions.

The inner duct 2 is fixed to the outer duct 1 such that two fixed portions 23 of the inner duct 2 extending outward from the reinforcement section 22 are inserted between the flanged portions 10 of the outer duct 1. As a result, a space 3 including a layer of air is formed between the inner duct 2 and the outer duct 1. According to the above structure, the inner duct 2 is stably fixed, and an inner duct can be fixed and a gap between the inner duct 2 and the outer duct 1 is kept to have a specified amount even in an environment such as the engine, in which the silencer itself is easy to be influenced by vibration.

In addition, a plurality of communicating holes 1A is formed on both end portions of the major diameter portion of the outer duct 1 in a circumferential direction of the major diameter portion. The space 3 and the outside communicate through the communicating hole 1A. According to the sizes and number of the communicating holes 1A, a sound having comparatively high sound pressure in a narrow band is attenuated, and noise reduction is performed in a comparatively wide band.

FIG. 10A shows an enlarged view in which an area 100 of the outer duct 1 is enlarged. Many projections 100a having conical shapes are formed for reducing noise on the whole inner circumference of the outer duct 1. Accordingly, a sound is diffuse on the inner circumferential surface of the outer duct 1 to be effectively attenuated. Projection 100b or a sound absorbing material 100c in respective FIGS. 10B, 10C may be provided instead of the projections 100a.

Workings of the first embodiment are explained below. According to the above configuration, the sound generated on an upstream side, on a downstream side, or inside of the inner duct 2 vibrates the film of resin which constitutes the inner duct 2, and thereby the inner duct 2 absorbs energy of the sound. At the same time, the sound permeates the film, thereby interfering with each other to be attenuated in the space 3 between the inner duct 2 and the outer duct 1. As a result, the noise is attenuated effectively. The inner duct 2 includes the films having a plurality of vibrating surfaces on its whole circumference, and the vibrating surfaces are connected to each other via the reinforcement sections 22, 24 at which the film is bent. Accordingly, the vibrating surface of the inner duct 2 vibrates easily, thereby attenuating the sound in a comparatively broad frequency range. As well, the sound having comparatively high sound pressure in a narrow band is attenuated. Moreover, since the vibrating surfaces are connected to each other via the reinforcement sections 22, 24 at which the film is bent, a configuration of the silencer is comparatively simple and a profound silencing effect is produced. In addition, the reinforcement section 22 may be formed at least two positions of the inner duct 2 that are opposed to each other. Accordingly, since the inner duct 2 is fixed to the outer duct 1 at the reinforcement sections 22 that are opposed to each other, even though the inner duct 2 is not fixed at every reinforcement section, the deformation of the inner duct 2 due to a pulsatile pressure of gas flowing through the inner duct 2 is restricted effectively using a simple configuration of the silencer. Furthermore, the film of resin is formed to be thin to such an extent that the film has a necessary thickness for its vibration with the necessary strength of the inner duct 2 maintained, and the strength of the reinforcement sections 22, 24 is ensured.

Moreover, according to the above configuration, the noise in a broad band which is easy to generate inside the engine or in the intake valve, and the noise having a high sound pressure, are reduced efficiently without enlarging the air intake duct of the engine so much. In addition, because the inner duct 2 has a hexagonal cross-sectional surface and the film vibrates easily, its comparatively large vibrating amount is ensured. Because the film easily vibrates, a thickness of the film is made accordingly large, and thereby strength of the film is ensured.

### Second Embodiment

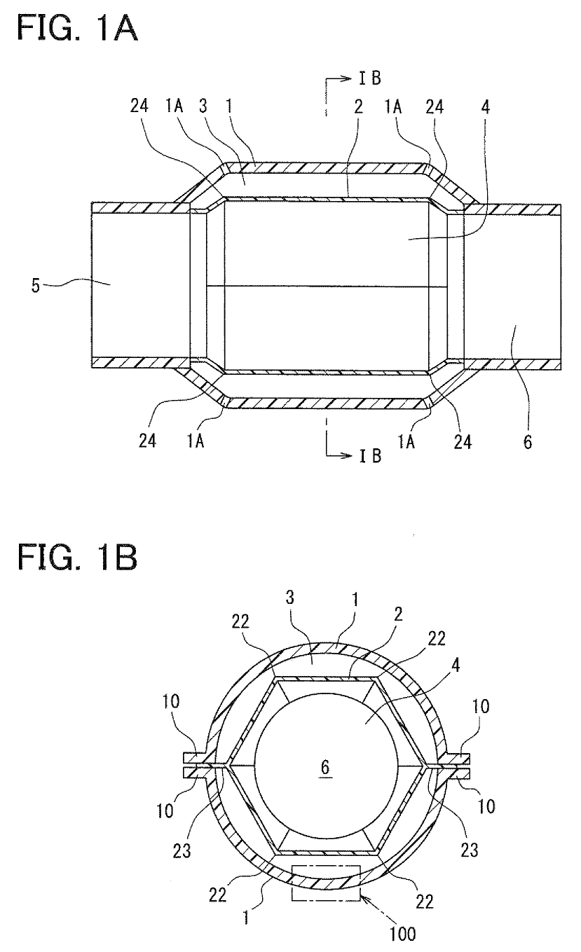

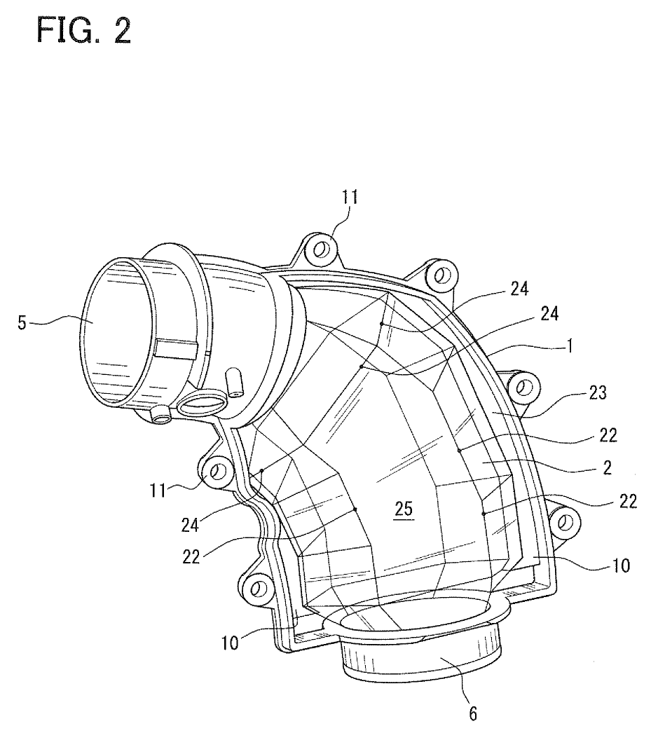

FIG. 2 shows a second embodiment of the invention. As shown in FIG. 2, the outer duct 1 and the inner duct 2 are crooked according to a space in an engine compartment. In the inner duct 2 having a hexagonal cross-sectional surface, vibrating surfaces 25 of a film of resin similar to the film in FIGS. 1A, 1B are connected to each other via a plurality of reinforcement sections 22, 24. The reinforcement section 22 is formed in a direction generally parallel to a flow direction of an intake air, and the reinforcement section 24 is formed in a direction generally perpendicular to the flow direction of the intake air. In addition, this silencer is fixed to a predetermined position in the engine compartment via an attaching portion 11.

Workings of the silencer of the second embodiment are substantially the same as those of the first embodiment. In the second embodiment, the vibrating surfaces 25 are connected to each other via the plurality of reinforcement sections 22, 24. The reinforcement section 22 is formed in the direction generally parallel to the flow direction of the intake air, and the reinforcement section 24 is formed in the direction generally perpendicular to the flow direction of the intake air. Particularly because the reinforcement section 24 is formed along a bending direction of the inner duct 2, the inner duct 2 is easily crooked with the vibrating surface 25 fully ensured.

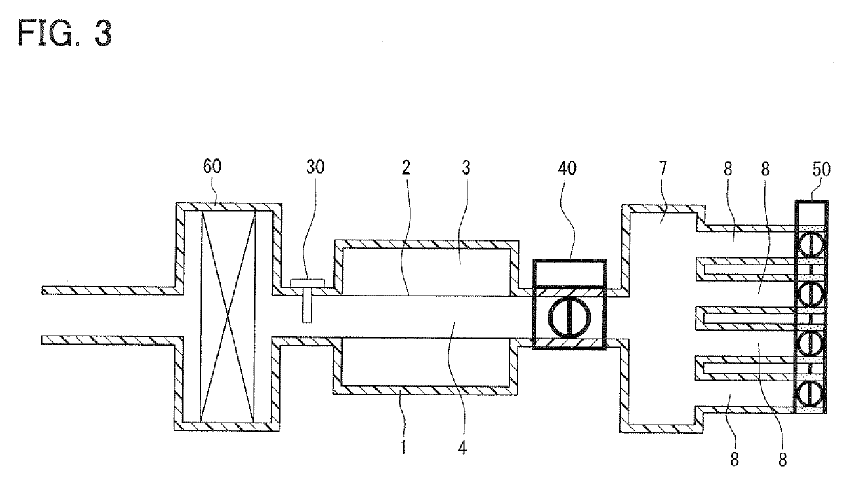

As shown in FIG. 3, the upstream side portions of the outer duct 1 and the inner duct 2 of the silencer communicate with an air cleaner 60 of the engine, and the downstream side portions of the outer duct 1 and the inner duct 2 communicate with a surge tank 7 and an intake manifold 8 of the engine. An air flow meter 30 detects an amount of intake air flowing through the passage 4 in the inner duct 2. A throttle device 40 adjusts the amount of intake air. An intake control valve 50 regulates the amount of intake air flowing in the intake manifold 8, and generates a vortex of intake air.

### Third Embodiment

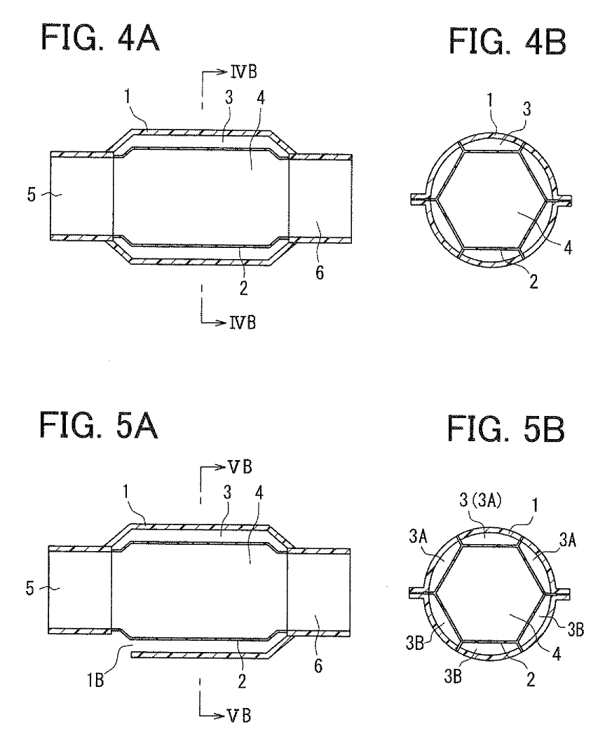

In a third embodiment of the invention, as shown in FIGS. 4A, 4B, An inner duct 2 is fixed to an outer duct 1 such that fixed portions extending outward from its six reinforcement sections are inserted in the outer duct 1 or fixed to the outer duct 1 by welding. A space 3 including a layer of air is formed between the inner duct 2 and the outer duct 1. By virtue of the above configuration, the inner duct 2 is even more firmly fixed to the outer duct 1.

### Fourth Embodiment

In a fourth embodiment of the invention, as shown in FIGS. 5A, 5B, an inner duct 2 is fixed to an outer duct 1 such that fixed portions extending outward from its six reinforcement sections are inserted in the outer duct 1 or fixed to the outer duct 1 by welding, which is similar to FIGS. 4A, 4B. A space 3A defined by an upper half of the outer duct 1 and the inner duct 2 is sealed, and a space 3B defined by a lower half of the outer duct 1 and the inner duct 2 is configured to be open to the outside at an opening 1B. By virtue of the above configuration, according to a size of the opening 1B, a spring-mass system is formed in the space 3A and a sound having comparatively high sound pressure in a narrow band is attenuated, while noise reduction is performed in a comparatively wide band in the space 3B.

### Fifth Embodiment

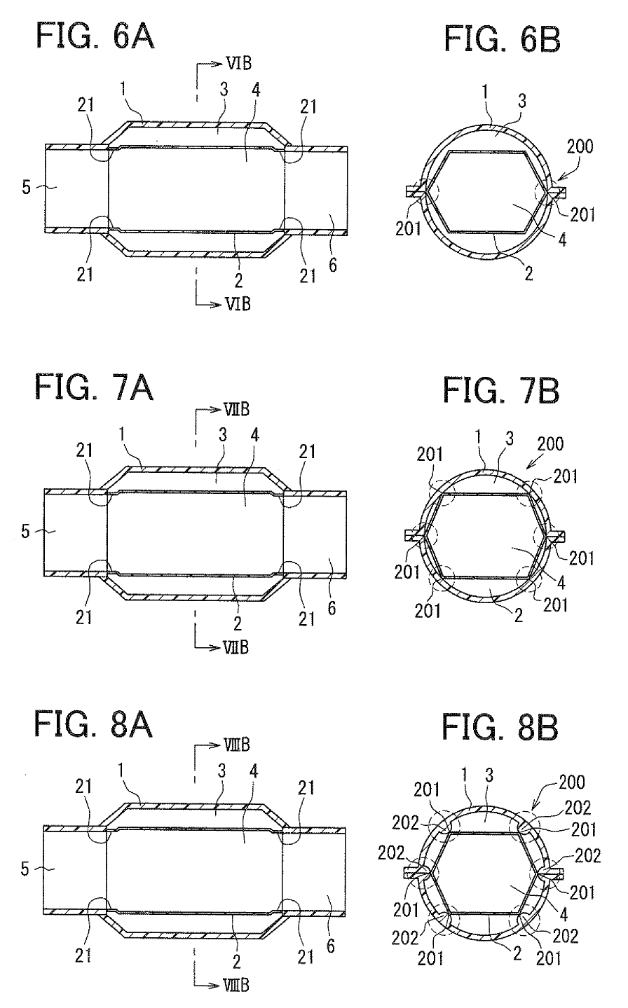

In a fifth embodiment of the invention, as shown in FIGS. 6A, 6B, an inner duct 2 has a flattened hexagonal cross-sectional surface, two sides of which opposed to each other are longer than the other sides, and is fixed to an outer duct 1 such that a diameter reduced portion 21 of an inner duct 2 is fixed to the outer duct 1. Two reinforcement sections opposed to each other, two short sides of the inner duct 2 crossing at each of the two reinforcement sections, are in contact with respective contact portions 201 of a contact position 200 on an inner circumferential surface of the outer duct 1.

By virtue of the above configuration, a negative pressure of intake air generated in the inner duct 2 makes vibrating surfaces constituting the long sides of their cross-sectional surface deform inward of the inner duct 2. Accordingly, the two reinforcement sections opposed to each other are made to deform outward of the inner duct 2 at the respective contact portions 201. However, the reinforcement sections are pressed on the inner circumferential surface of the outer duct 1, and thereby the deformation of the inner duct 2 is restricted. Therefore, the deformation of the inner duct 2 is restricted using a simple configuration of the silencer, and greater vibration of a film of the inner duct 2 is ensured. Moreover, when the inner duct 2 has a flat shape, the outer duct 1 may also be formed in a flat shape according to need. Accordingly, the flexibility in arrangement of the silencer is improved. In addition, by fixing the two reinforcement sections opposed to each other to the outer duct 1, disposing them in contact with the outer duct 1, or situating them closely to the outer duct 1, the deformation of the entire inner duct 2 is considerably restricted.

In addition, the reinforcement sections of the inner duct 2 at the contact position 200 may be positioned close to the inner circumferential surface of the outer duct 1 without contacting it with a minute clearance therebetween when there is no flow of air, such that the reinforcement sections are brought into contact with the inner circumferential surface when a pulsating pressures such as a negative pressure is generated.

### Sixth Embodiment

In a sixth embodiment of the invention, as shown in FIGS. 7A, 7B, an inner duct 2 has a flattened hexagonal cross-sectional surface, two sides of which opposed to each other are longer than the other sides, and is fixed to an outer duct 1 via its diameter reduced portion 21, which is similar to the fifth embodiment. Six reinforcement sections of the inner duct 2 are in contact with respective contact portions 201 of a contact position 200 on an inner circumferential surface of the outer duct 1.

By virtue of the above configuration as well, a negative pressure of intake air generated in the inner duct 2 makes vibrating surfaces constituting the long sides of their cross-sectional surface deform inward of the inner duct 2. Accordingly, the two reinforcement sections opposed to each other, two short sides of the inner duct 2 crossing in each of the two reinforcement sections, are made to deform outward of the inner duct 2 at the respective contact portions 201. However, the reinforcement sections are pressed on the inner circumferential surface of the outer duct 1, and thereby the deformation of the inner duct 2 is restricted. Therefore, even though a pulsatile pressure of gas flowing through the inner duct 2 is generated, the deformation of the inner duct 2 is restricted using a simple configuration of the silencer. As a result, durability of the inner duct 2 is improved. Although a positive pressure of intake air generated in the inner duct 2 makes each reinforcement section of the inner duct 2 extend outward of the inner duct 2, the outward deformation of the inner duct 2 is restricted effectively at the contact portions 201.

In addition, the reinforcement sections of the inner duct 2 at the contact position 200 may be positioned close to the inner circumferential surface of the outer duct 1 without contacting it with a minute clearance therebetween when there is no flow of air, such that the reinforcement sections are brought into contact with the inner circumferential surface when a pulsating pressures such as a negative pressure is generated. Accordingly, the inner duct 2 is easy to dispose in the outer duct 1. Even though a pulsatile pressure of gas flowing through the inner duct 2 is generated, the deformation of the inner duct 2 is restricted. As a result, durability of the inner duct 2 is improved, and a configuration of the silencer is made simple.

### Seventh Embodiment

In a seventh embodiment of the invention, as shown in FIGS. 8A, 8B, similar to the fifth embodiment, an inner duct 2 has a flattened hexagonal cross-sectional surface, two sides of which opposed to each other are longer than the other sides, and is fixed to an outer duct 1 via its diameter reduced portion 21. Moreover, a projection 202 having an arc shaped cross-sectional surface is formed in a position on an inner circumferential surface of the outer duct 1 opposed to a reinforcement section of the inner duct 2. The projection 202 has an embankment shape having a predetermined length, extending in a direction in which intake air flows. Six reinforcement sections of the inner duct 2 are in contact with the respective projections 202 at their corresponding contact portions 201 of a contact position 200.

According to the above configuration as well, a negative pressure of intake air generated in the inner duct 2 makes vibrating surfaces constituting the long sides of their cross-sectional surface deform inward of the inner duct 2. Accordingly, the two reinforcement sections opposed to each other, two short sides of the inner duct 2 crossing in each of the two reinforcement sections, are made to deform outward of the inner duct 2 at the respective contact portions 201. However, the reinforcement sections are pressed on the inner circumferential surface of the outer duct 1, and thereby the deformation of the inner duct 2 is restricted. Therefore, the deformation of the inner duct 2 is restricted using a simple configuration of the silencer. Although a positive pressure of intake air generated in the inner duct 2 makes each reinforcement section of the inner duct 2 extend outward of the inner duct 2, the outward deformation of the inner duct 2 is restricted effectively at the contact portions 201. Furthermore, since the inner duct 2 is in contact with the outer duct 1 at the projections 202, a gap between the inner duct 2 and the outer duct 1 is set to have a comparatively large value. Accordingly, the sound which has permeated the thin film is effectively attenuated.

In addition, the reinforcement sections of the inner duct 2 at the contact position 200 may be positioned close to the inner circumferential surface of the outer duct 1 without contacting it with a minute clearance therebetween when there is no flow of air, such that the reinforcement sections are brought into contact with the inner circumferential surface when a pulsating pressures such as a negative pressure is generated. In addition, a plurality of projections 202 having dome shapes may be arranged along the inner circumferential surface of the outer duct 1 in a direction in which the reinforcement sections extend.

### Eighth and Ninth Embodiments

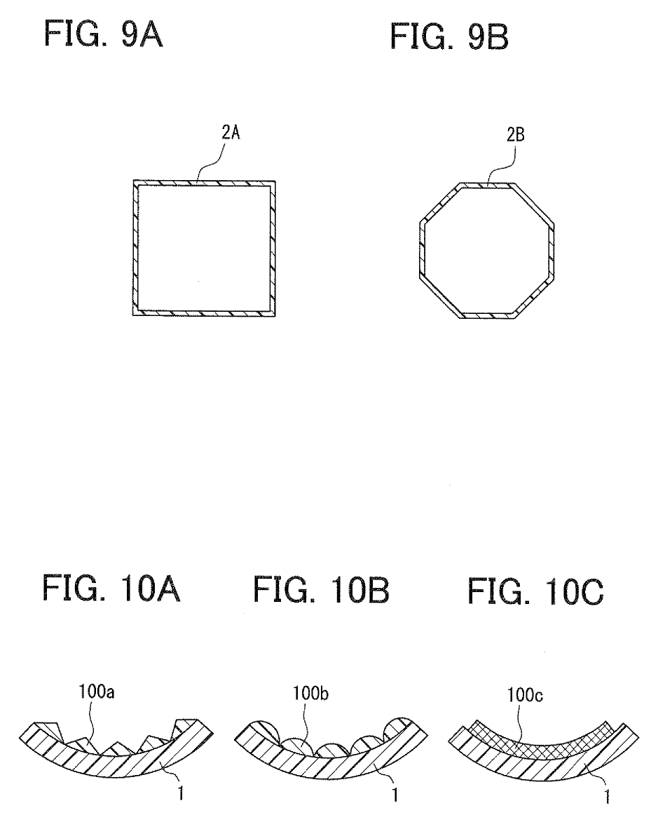

In an eighth embodiment of the invention, as shown in FIG. 9A, an inner duct 2A has a square cross-sectional surface. In a ninth embodiment of the invention, as shown in FIG. 9B, an inner duct 2B has a octagonal cross-sectional surface. By employing the above sectional shapes of the inner duct in the silencer, a silencing effect is also produced.

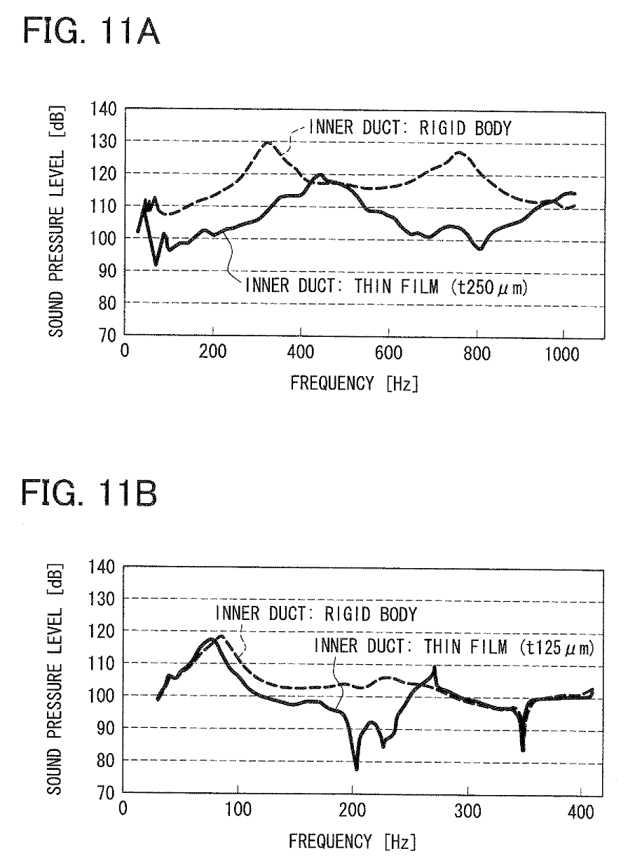

In graphs shown in FIGS. 11A, 11B illustrating noise reduction characteristics of the silencer of the invention, a frequency is indicated on their horizontal axes, and a sound pressure level is indicated on their vertical axes. FIG. 11B shows noise reduction characteristics in the embodiments in which the space between the inner duct and the outer duct is generally sealed. A continuous line in FIG. 11B indicates noise reduction characteristics in the first embodiment (125 micrometers of inner duct thickness) shown in FIGS. 1A, 1B. A dashed line in FIG. 11B indicates noise reduction characteristics as a comparative example when the inner duct is a rigid body. FIG. 11A shows noise reduction characteristics when the outer duct is comparatively wide open. A continuous line in FIG. 11A indicates noise reduction characteristics in the fourth embodiment (250 micrometers of inner duct thickness) shown in FIGS. 5A, 5B. A dashed line in FIG. 11A indicates noise reduction characteristics as a comparative example when the inner duct is a rigid body. In the silencer of the invention, as shown in FIGS. 11A, 11B, a low sound pressure level is achieved, and thereby a profound silencing effect is produced.

In the above embodiments, the inner duct includes a film of resin. Alternatively, the inner duct may include filmy metal or elastic bodies such as rubber. The plurality of vibrating surfaces of the inner duct is formed in a planar shape. Alternatively, the vibrating surface which is bent to some extent like a curved surface may be used as long as it vibrates.

As explained above, the invention is not limited to the above embodiments, and may be applied to various embodiments without departing from the scope of the invention.

Additional advantages and modifications will readily occur to those skilled in the art. The invention in its broader terms is therefore not limited to the specific details, representative apparatus, and illustrative examples shown and described.

What is claimed is:

1. A silencer for attenuating a sound, comprising:
an inner duct in which gas flows; and
an outer duct configured to surround an outside of the inner duct with a layer of gas formed between the outer duct and the inner duct, wherein:
the sound is generated in one of an upstream side of the inner duct in a flow direction of gas, a downstream side of the inner duct in the flow direction of gas, and an inside of the inner duct;
the inner duct includes a thin film over an entire surface thereof;
the thin film has a first reinforcement section that is formed in a direction parallel to the flow direction of gas, and a plurality of vibrating surfaces;
the thin film is bent at the first reinforcement section;
each combination of adjacent two of the plurality of vibrating surfaces is connected by the first reinforcement section; and
the inner duct is fixed to the outer duct such that the first reinforcement section of the inner duct is fixed to the outer duct.

2. The silencer according to claim 1, wherein:
the first reinforcement section includes a fixed portion projecting in a direction of the outer duct; and
the inner duct is fixed to the outer duct in one of the following manners:
the fixed portion of the first reinforcement section of the inner duct is inserted in the outer duct; and
the fixed portion is welded to the outer duct.

3. The silencer according to claim 1, wherein the first reinforcement section, which is fixed to the outer duct, is one of at least one pair of first reinforcement sections that are opposed to each other.

4. The silencer according to claim 1, wherein:
the inner duct has a second reinforcement section in addition to the first reinforcement section, which is formed in a direction generally parallel to the flow direction of gas, and at which the thin film is bent;
the second reinforcement section is formed in a direction generally perpendicular to the flow direction of gas; and
the thin film is bent at the second reinforcement section.

5. The silencer according to claim 1, wherein:
the inner duct and the outer duct constitute an air intake duct disposed on an upstream side of an internal-combustion engine; and
air, which is suctioned into the engine, flows through the air intake duct.

6. The silencer according to claim 1, wherein the thin film having the plurality of vibrating surfaces is made of resin.

7. The silencer according to claim 1, wherein the inner duct (2) has a polygonal cross-sectional surface, which is formed in a direction perpendicular to the flow direction of gas.

8. The silencer according to claim 7, wherein certain two sides of the polygonal cross-sectional surface that are opposed to each other are longer than the other sides of the surface.

9. The silencer according to claim 1, wherein the plurality of vibrating surfaces of the thin film is formed in a planar shape.

10. The silencer according to claim 1, wherein:
the layer of gas is a space formed between the outer duct and the inner duct;
a portion of the space formed in a circumferential direction of the inner duct is sealed; and
the other portion of the space formed in the circumferential direction of the inner duct opens to an outside of the outer duct.

11. The silencer according to claim 1, wherein:
the layer of gas is a space formed between the outer duct and the inner duct; and
the outer duct has a communicating hole, through which the space and an outside of the outer duct communicate.

12. The silencer according to claim 1, wherein the outer duct has many projections on an inner circumferential surface thereof.

13. The silencer according to claim 1, wherein the outer duct has a sound absorbing material on an inner circumferential surface thereof.

14. A silencer for attenuating a sound, comprising:
an inner duct in which gas flows; and
an outer duct configured to surround an outside of the inner duct with a layer of gas formed between the outer duct and the inner duct, wherein:
the sound is generated in one of an upstream side of the inner duct in a flow direction of gas, a downstream side of the inner duct in the flow direction of gas, and an inside of the inner duct;
the inner duct includes a thin film over an entire perimeter thereof;
the thin film has a first reinforcement section that is formed in a direction parallel to the flow direction of gas, and a plurality of vibrating surfaces;
the thin film is bent at the first reinforcement section;
each combination of adjacent two of the plurality of vibrating surfaces is connected by the first reinforcement section; and
the first reinforcement section of the inner duct is in contact with an inner circumferential surface of the outer duct when gas does not flow in the inner duct.

15. The silencer according to claim 14, wherein the first reinforcement section, which is in contact with the inner circumferential surface of the outer duct, is one of at least one pair of first reinforcement sections that are opposed to each other.

16. The silencer according to claim 14, further comprising a plurality of projections on the inner circumferential surface of the outer duct, wherein the first reinforcement section of the inner duct is in contact with the plurality of projections.

17. The silencer according to claim 14, wherein:
the inner duct has a second reinforcement section in addition to the first reinforcement section, which is formed in a direction generally parallel to the flow direction of gas, and at which the thin film is bent;
the second reinforcement section is formed in a direction generally perpendicular to the flow direction of gas; and
the thin film is bent at the second reinforcement section.

18. The silencer according to claim 14, wherein:
the inner duct and the outer duct constitute an air intake duct disposed on an upstream side of an internal-combustion engine; and
air, which is suctioned into the engine, flows through the air intake duct.

19. The silencer according to claim 14, wherein the thin film having the plurality of vibrating surfaces is made of resin.

20. The silencer according to claim 14, wherein the inner duct has a polygonal cross-sectional surface, which is formed in a direction perpendicular to the flow direction of gas.

21. The silencer according to claim 20, wherein certain two sides of the polygonal cross-sectional surface that are opposed to each other are longer than the other sides of the surface.

22. The silencer according to claim 14, wherein the plurality of vibrating surfaces of the thin film is formed in a planar shape.

23. The silencer according to claim 14, wherein:
the layer of gas is a space formed between the outer duct and the inner duct;
a portion of the space formed in a circumferential direction of the inner duct is sealed; and
the other portion of the space formed in the circumferential direction of the inner duct opens to an outside of the outer duct.

24. The silencer according to claim 14, wherein:
the layer of gas is a space formed between the outer duct and the inner duct; and
the outer duct has a communicating hole, through which the space and an outside of the outer duct communicate.

25. The silencer according to claim 14, wherein the outer duct has many projections on an inner circumferential surface thereof.

26. The silencer according to claim 14, wherein the outer duct has a sound absorbing material on an inner circumferential surface thereof.

27. A silencer for attenuating a sound, comprising:
an inner duct in which gas flows; and
an outer duct configured to surround an outside of the inner duct with a layer of gas formed between the outer duct and the inner duct, wherein:
the sound is generated in one of an upstream side of the inner duct in a flow direction of gas, a downstream side of the inner duct in the flow direction of gas, and an inside of the inner duct;
the inner duct includes a thin film over an entire perimeter thereof;
the thin film has a first reinforcement section that is formed in a direction parallel to the flow direction of gas, and a plurality of vibrating surfaces;
the thin film is bent at the first reinforcement section;
each combination of adjacent two of the plurality of vibrating surfaces is connected by the first reinforcement section; and
the first reinforcement section of the inner duct is brought into contact with an inner circumferential surface of the outer duct when the inner duct is deformed in a direction of the outer duct due to a change of pressure of gas.

28. The silencer according to claim 27, wherein the inner duct is arranged such that a minute clearance is formed between the first reinforcement section and the outer duct when gas does not flow in the inner duct.

29. The silencer according to claim 27, wherein the first reinforcement section, which is brought into contact with the inner circumferential surface of the outer duct when the inner duct is deformed in the direction of the outer duct, is one of at least one pair of first reinforcement sections that are opposed to each other.

30. The silencer according to claim 27, further comprising a plurality of projections on the inner circumferential surface of the outer duct, wherein the first reinforcement section of the inner duct is in contact with the plurality of projections.

31. The silencer according to claim 27, wherein:
the inner duct has a second reinforcement section in addition to the first reinforcement section, which is formed in a direction generally parallel to the flow direction of gas, and at which the thin film is bent;
the second reinforcement section is formed in a direction generally perpendicular to the flow direction of gas; and
the thin film is bent at the second reinforcement section.

32. The silencer according to claim 27, wherein:
the inner duct and the outer duct constitute an air intake duct disposed on an upstream side of an internal-combustion engine; and
air, which is suctioned into the engine, flows through the air intake duct.

33. The silencer according to claim 27, wherein the thin film having the plurality of vibrating surfaces is made of resin.

34. The silencer according to claim 27, wherein the inner duct has a polygonal cross-sectional surface, which is formed in a direction perpendicular to the flow direction of gas.

35. The silencer according to claim 34, wherein certain two sides of the polygonal cross-sectional surface that are opposed to each other are longer than the other sides of the surface.

36. The silencer according to claim 27, wherein the plurality of vibrating surfaces of the thin film is formed in a planar shape.

37. The silencer according to claim 27, wherein:
the layer of gas is a space formed between the outer duct and the inner duct;
a portion of the space formed in a circumferential direction of the inner duct is sealed; and
the other portion of the space formed in the circumferential direction of the inner duct opens to an outside of the outer duct.

38. The silencer according to claim 27, wherein:
the layer of gas is a space formed between the outer duct and the inner duct; and
the outer duct has a communicating hole, through which the space and an outside of the outer duct communicate.

39. The silencer according to claim 27, wherein the outer duct has many projections on an inner circumferential surface thereof.

40. The silencer according to claim 27, wherein the outer duct has a sound absorbing material on an inner circumferential surface thereof.
